(19) United States
(12) Patent Application Publication
(10) Pub. No.: US 2024/0017594 A1
(43) Pub. Date: Jan. 18, 2024

(54) PORTABLE COOLING KIT FOR LAST MILE COOLING

(71) Applicant: Carrier Corporation, Palm Beach Gardens, FL (US)

(72) Inventor: Srinivasa Reddy Pilli, Hyderabad (IN)

(21) Appl. No.: 18/350,175

(22) Filed: Jul. 11, 2023

Related U.S. Application Data
(60) Provisional application No. 63/389,151, filed on Jul. 14, 2022.

(51) Int. Cl. B60H 1/00; B60P 3/20; B60H 1/32

(52) U.S. Cl. CPC B60H 1/00899; B60P 3/20; B60H 1/00735; B60H 1/32

(57) ABSTRACT

A portable cooling system for cooling a compartment containing perishable items includes a fluid source including a cryogenic fluid and a heat exchanger assembly. The heat exchanger assembly includes a heat exchanger arranged in fluid communication with the fluid source to form a closed loop and a fan associated with the heat exchanger and operable to move an air flow across the heat exchanger.

### CROSS-REFERENCE TO RELATED APPLICATIONS

This application claims the benefit of U.S. Application No. 63/389,151, filed Jul. 14, 2022, the contents of which are incorporated by reference herein in their entirety.

### BACKGROUND

Embodiments of the disclosure relate to transport refrigeration, and more particularly to an apparatus and method for cooling items during transport between a distribution area and a final destination.

Refrigerated trucks, trailers, and cargo containers are commonly used to transport perishable items, such as, for example, produce, meat, poultry, fish, dairy products, cut flowers, medicines, vaccines, and other fresh or frozen perishable products. A transport refrigeration system is associated with the container and is operable to maintain a controlled temperature environment within the interior or cargo space of the container.

Conventionally, transport refrigeration systems used in connection with refrigerated containers include a transport environmental control unit formed as a vapor compression system having a refrigerant compressor, a condenser (heat absorption heat exchanger) with one or more associated condenser fans, an expansion device, and an evaporator (heat rejection heat exchanger) with one or more associated evaporator fans, which are connected via appropriate refrigerant lines in a closed refrigerant flow circuit. Air or an air/gas mixture is drawn from the interior volume of the cargo space by means of the evaporator fan(s) associated with the evaporator, passed through the air side of the evaporator in heat exchange relationship with refrigerant whereby the refrigerant absorbs heat from the air, thereby cooling the air. The cooled air is then supplied back to the cargo space.

Currently last mile cooling is served by either dry ice or just insulated containers, there are few use cases where a smaller compressor driven system can be used due to size, weight, etc. Typically, the perishable cargo within the truck's transport refrigeration system is contained within simple cardboard boxes, wooden crates, or plastic containers and is cooled or heated by the truck's environmental control system. Upon arriving at a destination, the perishable cargo is unloaded onto a dock or other uncontrolled area where it may sit for hours until it could be moved to an environmentally controlled location. The perishable cargo may also need to be transported for the “last mile” to the consumer via a non-refrigerated means, such as a motorcycle or truck. This time spent on the dock or in “last mile” transit, out of a controlled environment, leads to the degradation of the product life and ultimately leads to a lower quality product being served to the end consumer. In some instances, the product may be unconsumable or unusable.

### BRIEF DESCRIPTION

According to an embodiment, a portable cooling system for cooling a compartment containing perishable items includes a fluid source including a cryogenic fluid and a heat exchanger assembly. The heat exchanger assembly includes a heat exchanger arranged in fluid communication with the fluid source to form a closed loop and a fan associated with the heat exchanger and operable to move an air flow across the heat exchanger.

In addition to one or more of the features described above, or as an alternative, in further embodiments the fluid source includes a plurality of containers of cryogenic fluid.

In addition to one or more of the features described above, or as an alternative, in further embodiments the heat exchanger is a round tube plate fin heat exchanger.

In addition to one or more of the features described above, or as an alternative, in further embodiments comprising a control system including at least one environmental parameter detector operable to detect an environmental parameter of the compartment and a control module operably coupled to the at least one environmental parameter detector. The control module is configured to control operation of the portable cooling system in response to the environmental parameter detected by the at least one environmental parameter detector.

In addition to one or more of the features described above, or as an alternative, in further embodiments the environmental parameter is temperature.

In addition to one or more of the features described above, or as an alternative, in further embodiments the control module is configured to control a rotational speed of the fan in response to the temperature detected by the at least one environmental parameter detector.

In addition to one or more of the features described above, or as an alternative, in further embodiments the environmental parameter is an oxygen level.

In addition to one or more of the features described above, or as an alternative, in further embodiments the control module is configured to direct a flow of the cryogenic fluid provided at an outlet of the heat exchanger in response to the oxygen level detected by the at least one environmental parameter detector.

In addition to one or more of the features described above, or as an alternative, in further embodiments the control module is operable to control a breather valve in response to the oxygen level detected by the at least one environmental parameter detector.

According to an embodiment, a vehicle includes at least one cargo compartment configured to receive a perishable item therein and at least one portable cooling system removably installable within the vehicle in fluid communication with the at least one cargo compartment. The portable cooling system includes a closed loop circuit through which a cryogenic fluid circulates.

In addition to one or more of the features described above, or as an alternative, in further embodiments the at least one cargo compartment further comprises a plurality of cargo compartments.

In addition to one or more of the features described above, or as an alternative, in further embodiments the at least one portable cooling system is arranged in fluid communication with each of the plurality of cargo compartments.

In addition to one or more of the features described above, or as an alternative, in further embodiments the at least one portable cooling system further comprises a plurality of portable cooling systems, each of the plurality of portable cooling systems being associated with a respective cargo compartment of the plurality of cargo compartments.

In addition to one or more of the features described above, or as an alternative, in further embodiments the at least one portable cooling system further comprises a fluid source including at least one container of cryogenic fluid and a heat exchanger assembly comprising a heat exchanger arranged in fluid communication with the fluid source and a fan associated with the heat exchanger and operable to move an air flow across the heat exchanger.

According to an embodiment, a method of operating a portable cooling system includes detecting, via an environmental parameter detector, an environmental parameter of a cargo compartment containing a perishable item, determining, based on the perishable item, an allowable threshold of the environmental parameter, comparing the environmental parameter detected by the environmental parameter detector to the allowable threshold, and adjusting operation of the portable cooling system in response to the environmental parameter being beyond the allowable threshold.

In addition to one or more of the features described above, or as an alternative, in further embodiments detecting the environmental parameter of the cargo compartment containing the perishable item further comprises detecting a temperature of the cargo compartment.

In addition to one or more of the features described above, or as an alternative, in further embodiments adjusting operation of the portable cooling system in response to the environmental parameter being beyond the allowable threshold further comprises adjusting a rotational speed of a fan of the portable cooling system.

In addition to one or more of the features described above, or as an alternative, in further embodiments detecting the environmental parameter of the cargo compartment containing the perishable item further comprises detecting an oxygen level of the cargo compartment.

In addition to one or more of the features described above, or as an alternative, in further embodiments adjusting operation of the portable cooling system in response to the environmental parameter being beyond the allowable threshold further comprises exhausting a portion of a cryogenic fluid circulating through the portable cooling system into the cargo compartment.

In addition to one or more of the features described above, or as an alternative, in further embodiments in response to determining that the environmental parameter is within the allowable threshold, one of returning the cryogenic fluid circulating through the portable cooling system to a fluid source and exhausting the portion of the cryogenic fluid to an ambient atmosphere.

### BRIEF DESCRIPTION OF THE DRAWINGS

The following descriptions should not be considered limiting in any way. With reference to the accompanying drawings, like elements are numbered alike:

FIG. 1 is a perspective view of an exemplary portable cooling system according to an embodiment;

FIG. 2 is a schematic diagram of a vehicle including a portable cooling system associated with a cargo compartment according to an embodiment;

FIG. 3 is a schematic diagram of a vehicle including a plurality of portable cooling systems associated with a plurality of cargo compartments according to an embodiment;

FIG. 4 is a schematic diagram of a control system of the portable cooling system according to an embodiment; and

FIG. 5 is a flow diagram of operational control of the portable cooling system performed in response to detection of an environmental parameter of a cargo compartment according to an embodiment.

### DETAILED DESCRIPTION

A detailed description of one or more embodiments of the disclosed apparatus and method are presented herein by way of exemplification and not limitation with reference to the Figures.

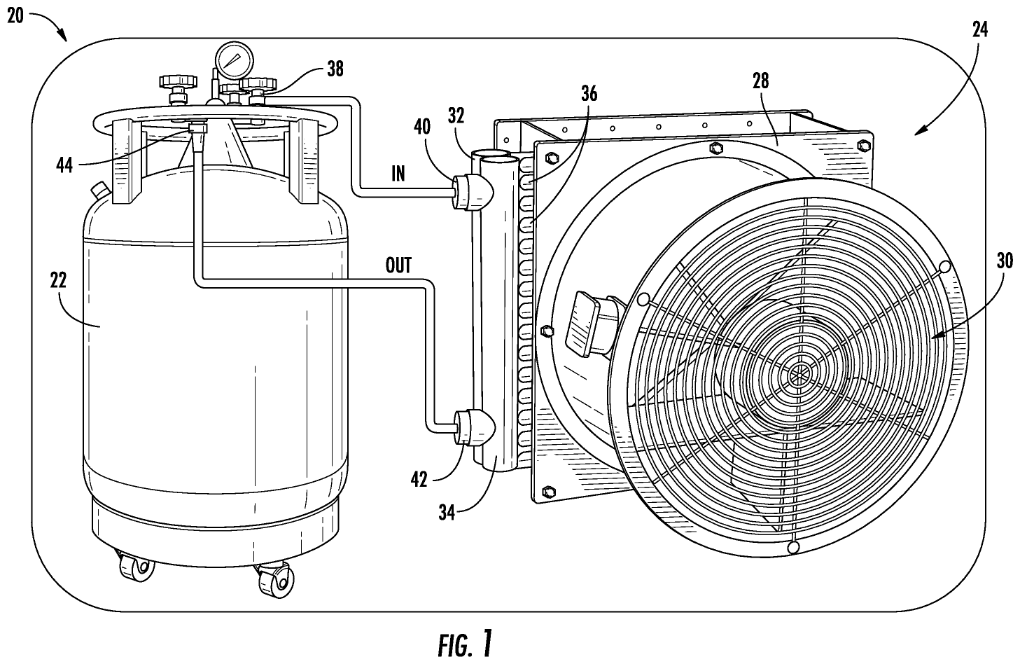

With reference now to FIG. 1, an example of a portable cooling system 20 is illustrated. As shown, the portable cooling system 20 includes a fluid source 22 and a heat exchanger assembly 24 operably coupled to the fluid source 22. In the illustrated, non-limiting embodiment, the fluid source 22 includes at least one container 26, for example a cylinder, of a cryogenic fluid. Although only a single container 26 is illustrated, it should be appreciated that embodiments including a plurality of containers 26 of cryogenic fluid are also within the scope of the disclosure. Further, in embodiments including a plurality of containers 26 of cryogenic fluid, the cryogenic fluid within each container 26 may be the same, or alternatively, may be different. Examples of suitable cryogenic fluids include, but are not limited to Oxygen, Nitrogen, Helium, and Argon for example.

The heat exchanger assembly 24 includes a heat exchanger 28 and a fan 30 associated with the heat exchanger 28. In the illustrated, non-limiting embodiment, the heat exchanger 28 includes an inlet header 32, an outlet header 34, and a plurality of heat exchange members 36 extending between and fluidly coupling the inlet header 32 and the outlet header 34. A plurality of passages (not shown) is formed between adjacent heat exchange members 36. In an embodiment, the heat exchanger 28 is selected from a microchannel heat exchanger and a round tube plate fin heat exchanger. However, it should be appreciated that the heat exchanger 28 may be any suitable type of heat exchanger. As shown, an outlet 38 of the fluid source 22 may be arranged in fluid communication with an inlet 40 formed at the inlet header 32. Similarly, an outlet 42 formed in the outlet header 34 may be fluidly connected to an inlet 44 of the fluid source 22. With this connection between the fluid source 22 and the inlet 40 and outlet 42 of the heat exchanger 28, the portable cooling system 20 may have a closed-loop configuration. In an embodiment, the pressurization of the cryogenic fluid may be sufficient to circulate the cryogenic fluid between the fluid source 22 and the heat exchanger 28. However, in other embodiments, the portable cooling system 20 may include a pump (not shown) for moving the cryogenic fluid through the closed loop system.

As shown in FIG. 1, the fan 30 may be positioned adjacent to a first side of the heat exchanger 28 and is operable to draw air through the passages and across one or more surfaces of the adjacent heat exchange members 36. In other embodiments, the fan 30 may be operable to push or blow air through the passages. Although the fan 30 is illustrated as being integrated into the same housing as the heat exchanger 28, embodiments where the fan 30 is a component separate from and movable relative to the heat exchanger 28 are also contemplated herein.

As the cryogenic fluid flows from the fluid source 22 through the one or more heat exchange members 36, heat is transferred from the air at the heat exchanger 28 to the cryogenic fluid, resulting in a cool air. In an embodiment, the temperature of the air output from the heat exchanger 28 into a compartment to be cooled has a temperature between about −10° C. and about 5° C. However, it should be appreciated that the temperature is varied to any suitable type of goods, and may be less than −10° C. or greater than 5° C. In addition, it should be appreciated that one or more operational parameters of the portable cooling system 20, such as the rotational speed of the fan 30 for example, may be controlled to achieve an air flow having a temperature outside of this range.

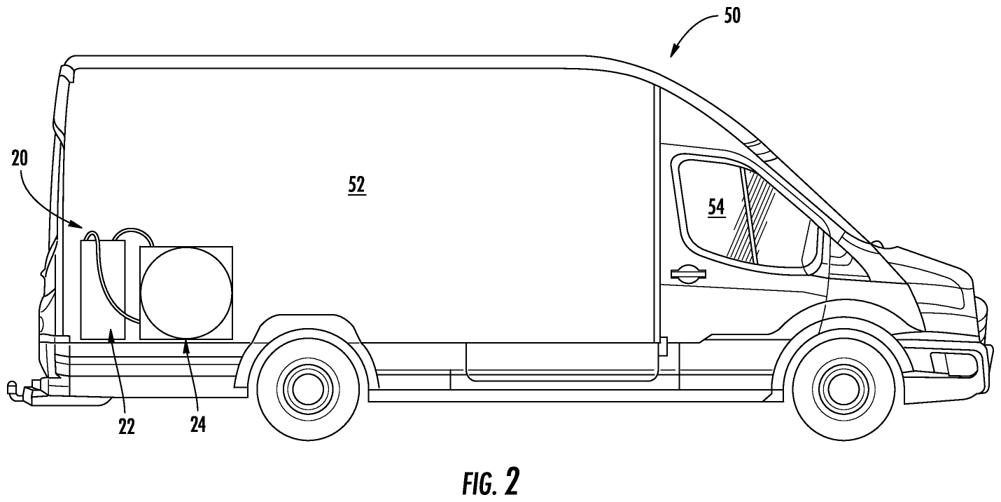

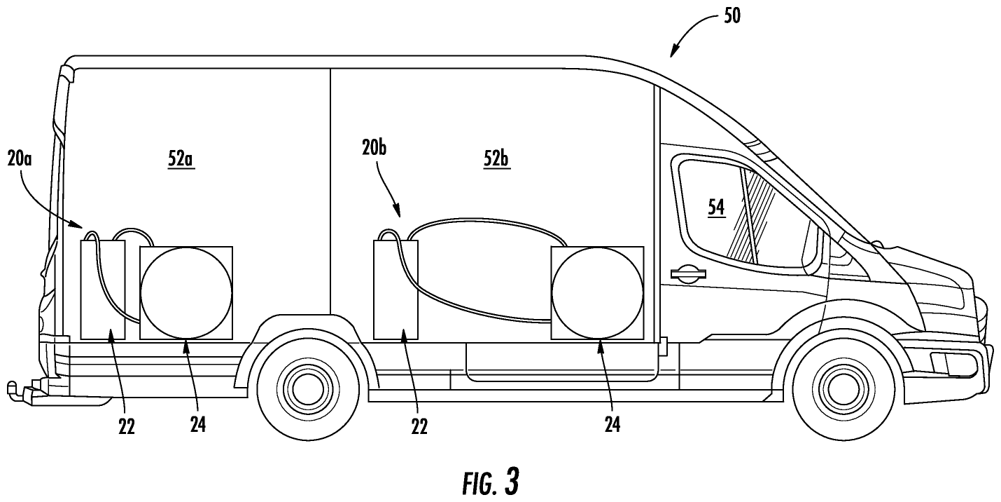

With reference now to FIGS. 2 and 3, an example of a vehicle 50, such as a utility truck or van for example, having at least one cargo compartment 52 to be cooled by at least one portable cooling system 20 is illustrated. As shown, the at least one cargo compartment 52 may be disposed at the rear of the vehicle 50 and is fluidly and/or thermally separated from a passenger compartment 54 of the vehicle 50. A portable cooling system 20 is arranged in fluid communication with the at least one cargo compartment 52. In embodiments including a plurality of cargo compartments 52a, 52b, depending on the cooling demands of each compartment, a single portable cooling system 20 may be associated with multiple compartments, or alternatively, a distinct portable cooling system 20a, 20b may be associated with each cargo compartment 52a, 52b (see FIG. 3).

The components of the one or more portable cooling systems 20 may be fixedly mounted at a location about the vehicle 50, such as within a respective cargo compartment 52 for example. In an embodiment, the fluid source 22 and the heat exchanger assembly 24 may be positioned close to, and in some embodiments, directly adjacent to one another. In other embodiments, such as depending on the configuration of the cargo compartment 52 and the available space therein, the fluid source 22 and the heat exchanger assembly 24 may be separated from one another, such as at different ends and/or sides of the cargo compartment 52 for example. Accordingly, to adapt a portable cooling system 20 for use in any potential configuration, the conduits 56 connecting the fluid source 22 and the heat exchanger 28 may be formed from a flexible material.

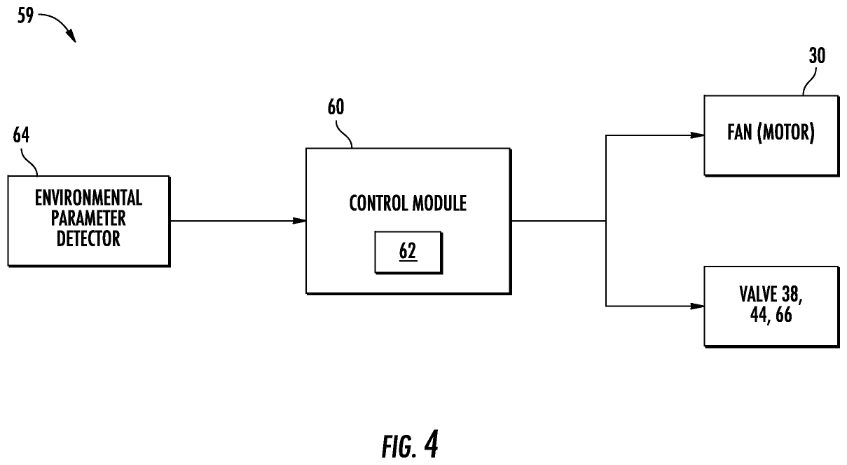

With reference now to FIG. 4, the portable cooling system 20 may include a control system 59 including a control module 60 having a computer readable processor 62 and at least one environmental parameter detector 64. The environmental parameter detector 64 may be located within and configured to monitor and/or measure at least one environmental parameter of a cargo compartment 52 associated with the portable cooling system 20 and output an associated signal to the control module 60. The processor 62 of the control module 60 may be configured to process the signal and second a corresponding signal to a component of the portable cooling system 20 to control and maintain any variety of environmental parameters. It should be appreciated that in embodiments including a plurality of portable cooling systems 20, the control module 60 may be shared by some or each of the portable cooling systems. However, embodiments where each system has a distinct control module 60 are also within the scope of the disclosure.

The at least one environmental parameter being monitored may be dependent on the type of products being stored and/or transported within a compartment and may dictate the type of environmental parameter detector 64 utilized. For example, if the environmental parameter being monitored is temperature, the at least one environmental parameter detector includes a temperature sensor. Alternatively, or in addition, the at least one environmental parameter detector may include an oxygen sensor operable to detect a level or oxygen within the compartment.

A signal generated by the environmental parameter detector 64 may be communicated to a control module of the portable cooling system via a wired or a wireless pathway. Further, the environmental parameter detector 64 may be mounted at any suitable location, such as at or adjacent to a container 26 of the fluid source 22, the heat exchanger 28, the fan 30, or any location therebetween. In other embodiments, the environmental parameter detector 64 may be separate or remote from the one or more containers 26 of the fluid source 22, the heat exchanger 28, and the fan 30 of the portable cooling system 20.

In operation, the at least one environmental parameter detector 64 includes a temperature sensor configured to monitor the temperature within a corresponding cargo compartment 52 and communicate a signal representing the sensed temperature to the processor 62. In response to receiving the signal, the processor may access stored data, such as a plurality of tables for example, to determine whether or not the temperature within the compartment is acceptable. In an embodiment, each table is associated with a specific type of perishable product and may include one or more threshold values or ranges associated with one or more respective environmental parameters. The thresholds of the environmental parameters may be selected to preserve a perishable product and/or inhibit degradation (or further degradation) of the perishable product. It should be appreciated that a particular table or stored data may be preselected, such as via entering or selecting the contents to be stored and/or transported within the compartment for example, using a user interface (not shown) that communicates with the control module 60 and/or processor 62 thereof.

Once the relevant data has been accessed, the processor 62 may execute an algorithm to determine if the sensed temperature exceeds an allowable threshold. Upon determining that the temperature within the compartment exceeds the threshold, the processor 62 may generate a command signal to adjust operation of the portable cooling system 20. The command signal may be configured to adjust the temperature of the air output from the heat exchanger assembly 24. For example, the command signal may initiate or adjust operation of the fan 30. Alternatively, or in addition, the command signal may operate a valve associated with the outlet 38 and/or the inlet of the fluid source 22 to control the cooling that occurs within the heat exchanger 28.

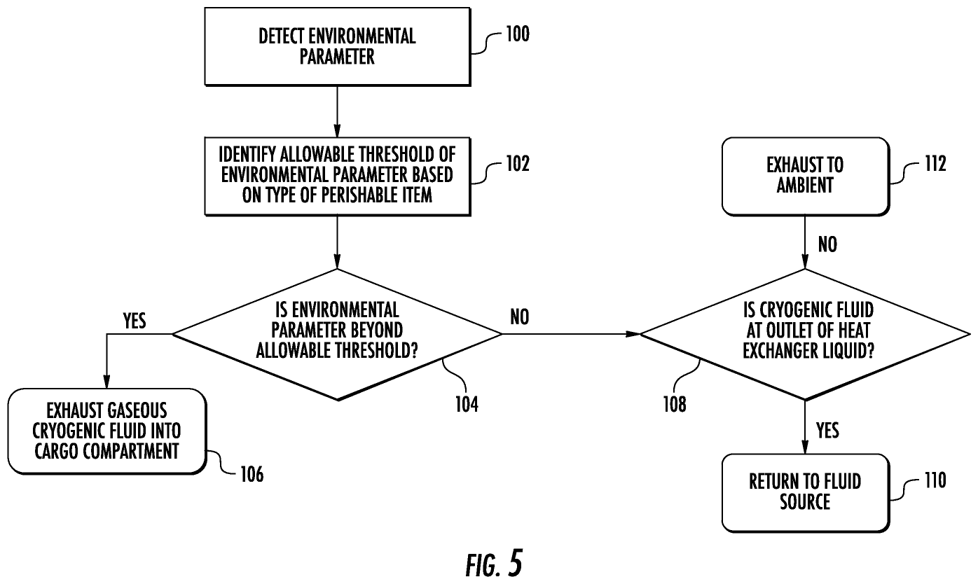

With reference to FIG. 5, in an embodiment, the at least one environmental parameter detector 64 includes an oxygen sensor. Similar to the temperature sensor previously described, the oxygen sensor is operable to monitor the oxygen within a corresponding cargo compartment 52 (see block 100) and communicate a signal representing the sensed oxygen level to the processor 62. Once the relevant data has been accessed (see block 102), the processor 62 will execute an algorithm to determine if the sensed oxygen is beyond an allowable threshold (see block 104). Upon determining that the oxygen within the cargo compartment 52 is beyond an allowable limit, for example the amount is less than a minimum allowable limit, a portion of the oxygen circulating within the closed loop of the portable cooling system 20 is exhausted into the cargo compartment 52. In such embodiments the portable cooling system 20 includes a breather valve 66, such as located downstream from the outlet 42 of the heat exchanger 28 and upstream from the inlet 44 of the fluid source 22. The processor 62 is operable to generate a command to selectively open the breather valve 66 to increase the oxygen within the cargo compartment 52 (see block 106). In an embodiment, the breather valve 66 will remain open until the oxygen level sensed by the oxygen sensor is at or exceeds the minimum allowable limit. In other embodiments, the breather valve 66 will remain open for a predetermined period of time.

In embodiments where the processor determines that the sensed oxygen level within the cargo compartment 52 is within an allowable limit, the cryogenic fluid either may be returned to the fluid source 22, or may be exhausted to the ambient atmosphere at an exterior of the compartment, and in some embodiments of the vehicle 50 based on the phase of the cryogenic fluid (block 108). The fluid stored within the container 26 may be a liquid. Accordingly, in embodiments where the cryogenic fluid output from the outlet 42 of the heat exchanger 28 is still a liquid, the cryogenic fluid may be returned to the container 26 (block 110). However, in embodiments where the heat transfer from the air to the cryogenic fluid has caused the cryogenic fluid to transform from a liquid phase to a gaseous phase, the cryogenic fluid will be exhausted to the ambient atmosphere (see block 112).

A portable cooling system 20 as illustrated and described herein provides a modular or plug and play type of system that can be easily installed into any vehicle to perform cooling. Further, readily available off the shelf products may be used as the container(s) 26 of the fluid source 22, making the system easily refillable.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made, and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A portable cooling system for cooling a compartment containing perishable items, the portable cooling system comprising:
a fluid source including a cryogenic fluid; and
a heat exchanger assembly comprising:
a heat exchanger arranged in fluid communication with the fluid source to form a closed loop; and
a fan associated with the heat exchanger and operable to move an air flow across the heat exchanger.

2. The portable cooling system of claim 1, wherein the fluid source includes a plurality of containers of cryogenic fluid.

3. The portable cooling system of claim 1, wherein the heat exchanger is a round tube plate fin heat exchanger.

4. The portable cooling system of claim 1, further comprising a control system including:
at least one environmental parameter detector operable to detect an environmental parameter of the compartment; and
a control module operably coupled to the at least one environmental parameter detector, wherein the control module is configured to control operation of the portable cooling system in response to the environmental parameter detected by the at least one environmental parameter detector.

5. The portable cooling system of claim 4, wherein the environmental parameter is temperature.

6. The portable cooling system of claim 5, wherein the control module is configured to control a rotational speed of the fan in response to the temperature detected by the at least one environmental parameter detector.

7. The portable cooling system of claim 4, wherein the environmental parameter is an oxygen level.

8. The portable cooling system of claim 7, wherein the control module is configured to direct a flow of the cryogenic fluid provided at an outlet of the heat exchanger in response to the oxygen level detected by the at least one environmental parameter detector.

9. The portable cooling system of claim 8, wherein the control module is operable to control a breather valve in response to the oxygen level detected by the at least one environmental parameter detector.

10. A vehicle comprising:
at least one cargo compartment configured to receive a perishable item therein; and
at least one portable cooling system removably installable within the vehicle in fluid communication with the at least one cargo compartment, the portable cooling system including a closed loop circuit through which a cryogenic fluid circulates.

11. The vehicle of claim 10, wherein the at least one cargo compartment further comprises a plurality of cargo compartments.

12. The vehicle of claim 11, wherein the at least one portable cooling system is arranged in fluid communication with each of the plurality of cargo compartments.

13. The vehicle of claim 12, wherein the at least one portable cooling system further comprises a plurality of portable cooling systems, each of the plurality of portable cooling systems being associated with a respective cargo compartment of the plurality of cargo compartments.

14. The vehicle of claim 10, wherein the at least one portable cooling system further comprises:
a fluid source including at least one container of cryogenic fluid; and
a heat exchanger assembly comprising:
a heat exchanger arranged in fluid communication with the fluid source; and
a fan associated with the heat exchanger and operable to move an air flow across the heat exchanger.

15. A method of operating a portable cooling system comprising:
detecting, via an environmental parameter detector, an environmental parameter of a cargo compartment containing a perishable item;
determining, based on the perishable item, an allowable threshold of the environmental parameter;
comparing the environmental parameter detected by the environmental parameter detector to the allowable threshold; and
adjusting operation of the portable cooling system in response to the environmental parameter being beyond the allowable threshold.

16. The method of claim 15, wherein detecting the environmental parameter of the cargo compartment containing the perishable item further comprises detecting a temperature of the cargo compartment.

17. The method of claim 16, wherein adjusting operation of the portable cooling system in response to the environmental parameter being beyond the allowable threshold further comprises adjusting a rotational speed of a fan of the portable cooling system.

18. The method of claim 15, wherein detecting the environmental parameter of the cargo compartment containing the perishable item further comprises detecting an oxygen level of the cargo compartment.

19. The method of claim 18, wherein adjusting operation of the portable cooling system in response to the environmental parameter being beyond the allowable threshold further comprises exhausting a portion of a cryogenic fluid circulating through the portable cooling system into the cargo compartment.

20. The method of claim 19, wherein in response to determining that the environmental parameter is within the allowable threshold, one of returning the cryogenic fluid circulating through the portable cooling system to a fluid source and exhausting the portion of the cryogenic fluid to an ambient atmosphere.
